(19) United States
(12) Patent Application Publication
(10) Pub. No.: US 2023/0158502 A1
(43) Pub. Date: May 25, 2023

(54) DROPLET SPACING

(71) Applicant: SPHERE FLUIDICS LIMITED, Great Abington, Cambridge Cambridgeshire (GB)

(72) Inventors: Dimitris Josephides, Great Abington, Cambridge Cambridgeshire (GB); James LONG, Great Abington, Cambridge Cambridgeshire (GB); Xin LI, Great Abington, Cambridge Cambridgeshire (GB)

(21) Appl. No.: 17/919,398

(22) PCT Filed: Apr. 17, 2020
(86) PCT No.: PCT/EP2021/059640

§ 371 Date: Oct. 17, 2022

(30) Foreign Application Priority Data
Apr. 17, 2020 (GB) 2005615.6

(51) Int. Cl. B01L 3/00

(52) U.S. Cl. CPC B01L 3/502784; B01L 2200/0636; B01L 2400/0487; B01L 2400/086; B01L 2300/0867

(57) ABSTRACT

We describe a microfluidic structure for spacing out droplets, the structure comprising: a main channel for guiding droplets in a spacing fluid; a first inlet for introducing droplets into the main channel; and a second inlet for introducing a spacing fluid into the main channel, wherein a cross-sectional area of the main channel decreases downstream from the first inlet. We also describe a method of spacing out droplets using a microfluidic structure.

### FIELD OF THE INVENTION

The present invention generally relates to microfluidic structures and methods for spacing out droplets in microfluidic structures.

### BACKGROUND TO THE INVENTION

Microfluidic droplet technology is an ultra-high throughput analysis approach of up to 1,000 Hz, which is especially useful for analysing and profiling large cell libraries containing, for example, from 10,000 to 100,000,000 cells at a single cell level.

The droplet manipulation techniques described herein generally, but not exclusively, relate to emulsions, typically comprising droplets of water in oil, generally surfactant-stabilised. One or more biological entities such as one or more particles or living cells may be incorporated into each droplet and then experiments performed within the droplet, for example to perform a biological assay. Microvolume droplets (microdroplets) can be generated and processed potentially at rates in excess of several thousand per second.

WO 14/057424 relates to microfluidic structure and technique for reacting products within droplets, US 2018/250677 relates to a method and structure for spacing out entities in an aqueous suspension, US 2014/037514 relates to a technique and microfluidic system for forming droplets, and US 2018/369817 relates to magnetophoretic separation of magnetic particles in fluidic channels.

Further background prior art can be found in: US2019/0002956, US2011/0311978, US2018/0117585, US2009/0126516, US 2005/0069459, and US2017/0173584.

In order to analyse individual droplets, the droplets need to be adequately spaced out within a microfluidic device to minimize the risk that two droplets are not processed together in error due to being too physically close. There is a requirement for a system and method for spacing out droplets within a microfluidic structure.

### SUMMARY OF THE INVENTION

According to a first aspect of the invention, there is provided a microfluidic structure for spacing out droplets, the structure comprising a main channel for guiding droplets in a spacing fluid; a first inlet for introducing droplets into the main channel; and a second inlet for introducing a spacing fluid into the main channel, wherein a cross-sectional area of the main channel decreases downstream from the first inlet. The cross-sectional area of the main channel may also decrease in the direction of flow starting upstream from the first inlet. The cross-sectional area decreases downstream from the second inlet and the first inlet, and the decreasing cross-sectional area increases the speed of the droplets and the spacing fluid travelling through the main channel. This pushes droplets away from each other and increases the distance between adjacent droplets as droplets are pushed away from each other when moving through the narrowing channel. Spacing out droplets herein refers to increasing spacing between droplets in the microfluidic structure.

Droplets are added into a stream of spacing fluid (this may be carrier oil) which then increases the spaces between multiple droplets by narrowing the main microfluidic channel. The spacing fluid may be a first liquid phase and the droplets may be a second liquid phase, wherein the first liquid phase is immiscible with the second liquid phase. For example, the droplets may be particles in an aqueous suspension and the spacing fluid may be a carrier oil.

In a preferred embodiment, the microfluidic structure may comprise a side channel opening into the main channel at the first inlet. As the inlet has a side channel opening onto the main channel, the droplets travelling through the side channel opening change direction which increases the distance between droplets when in the main channel.

One use of such a microfluidic structure may be to encapsulate a single or a small pool of cells in aqueous droplets using a carrier oil containing a fluorosurfactant. The spacing oil added later may be identical to the carrier oil or may have a different chemical composition.

The first inlet may be angled with respect to the main channel. At the first inlet, the side channel may be angled between 30° and 90° with respect to the main channel. Preferably the angle may be 90° with respect to the main channel. The angle between the side channel and the main channel causes a change of direction of droplets as they enter the main channel and causes the droplets to become more spaced apart.

The first inlet may be arranged on a first side of the main channel, and the main channel may comprise a droplet spacing region in which the first side of the main channel is straight and a second side of the main channel opposite the first side converges towards the first side of the main channel. The second side of the main channel may be sloping towards the first side of the main channel. This means that the width of the main channel tapers down in the direction of flow starting from the first inlet. Droplets flow along the first side of the main channel, and spacing fluid flowing along the second side of the main channel is forced towards the centre of the main channel by the converging second side. Droplets and spacing fluid merge progressively as the width of the main channel reduces, which spaces out the droplets.

In other words, a side of the main channel may be sloped with respect to the direction of the main channel. The side of the main channel that is sloped may be opposite to the side channel at the first inlet. The direction of the main channel may be defined as the axial direction of the main channel or a direction of flow within the main channel. The sloping side or sidewall of the main channel may be on an opposite side of the main channel to the first inlet for introducing droplets. This reduces the cross-sectional area of the main channel and increases spacing between droplets in the main channel.

The second inlet may be upstream from the first inlet. The second inlet being upstream of the first inlet may refer to the second inlet being upstream in the direction of flow of the spacing fluid in the main channel. Having the second inlet upstream means that droplets enter the main channel downstream of the inlet where spacing fluid enters the main channel.

The microfluidic structure may further comprise an outlet channel from the main channel, wherein a spacing between droplets in the main channel increases as the droplets flow through the main channel into the outlet channel. The outlet channel provides a flow of spaced out droplets.

The microfluidic structure may further comprise a dilution chamber; a droplet inlet for introducing droplets into the dilution chamber; a carrier fluid inlet for introducing a flow of carrier fluid into the dilution chamber; and a dilution chamber outlet. The first inlet may be configured to receive droplets from the dilution chamber outlet, and the dilution chamber may be configured such that droplets flow through the dilution chamber outlet arranged one behind each other. Droplets arriving from the droplet inlet with very little carrier fluid are compressed and the droplets try to minimise their surface area to volume ratio. This results in droplets being in a zig-zag arrangement. The carrier fluid inlet adds extra carrier oil into the dilution chamber, which then aligns the droplets so that they arrive at the first inlet in single file (in series, coming one after another in succession). This improves the regular spacing of the droplets downstream in the microfluidic structure.

In a further preferred embodiment, the second inlet may comprise a grid across the main channel. The grid across the main channel may comprise an array of inline filters.

The microfluidic structure may further comprise a flow-aligning structure for aligning the flow of the spacing fluid into the second inlet, wherein the flow aligning structure is located upstream of the second inlet. The flow aligning structure may also be upstream of the first inlet, where droplets enter the main channel. This refers to the grid of dots behind the semi-circular group of dots. The flow aligning structure may comprise a plurality of channels. The flow aligning structure may comprise a series of rows of channels in the direction of flow, wherein each channel may have an opening aperture to allow fluid to enter and one or more smaller exit apertures to reduce an amount or speed of fluid flowing through each channel. The exit apertures may be smaller than the opening apertures, and the exit apertures may be downstream from the opening apertures. The flow-aligning structure channels capture small particles. The rows of channels may be offset with respect to each other, so that the exit aperture of one channel is aligned with a gap between channels in an adjacent row of channels. This blocks large fibres and other unwanted objects.

The main channel may have a teardrop shape. The teardrop shape has a reducing cross-section, with sidewalls on both sides of the teardrop sloping. These forces spacing fluid from both sides of the teardrop towards the centre, which spaces out droplets in the main channel.

The microfluidic structure may comprise a spacing chamber, wherein the main channel is inside the spacing chamber. The first inlet may be configured to introduce droplets into the main channel from outside a plane of the microfluidic structure. The microfluidic structure may further comprise a third inlet configured to introduce a flow of spacing fluid into the spacing chamber.

The microfluidic structure may further comprise an outlet channel from the main channel; and a first funnel structure with a funnel opening, wherein the funnel opening has a first region configured to receive the spacer fluid and a second region configured to receive droplets from the outlet channel, and wherein the funnel structure has a funnel outlet in which, in use, droplets are spaced out further than in the output channel. in other words, droplets from the outlet channel and spacer fluid may feed into the first funnel structure, both at the funnel opening. The funnel structure may have a decreasing cross-sectional area from the funnel opening, which spaces out droplets so that they are spaced out further at the funnel outlet than in the output channel.

The second region may be substantially parallel to the first region such that spacing fluid entering the funnel structure flows parallel to the flow of spacing fluid and droplets from the first region.

The second region may be a central region of the funnel opening and the first region may lie to either side of the second region. Alternatively, the second region may be one side of the funnel opening, and the first region may be another side of the funnel opening so the first and second regions are side by side. Droplets flow into the funnel structure from the second region, and spacing fluid enters from the first region on either side. The spacing fluid from either side increases the distance between droplets.

The microfluidic structure may further comprise a funnel channel, wherein the funnel structure is inside the funnel channel, and wherein a cross-sectional area of the funnel channel decreases downstream from the funnel opening. In other words, the funnel structure is located in a larger funnel channel, which has a narrowing region in which the funnel structure is located. The narrowing funnel channel forces spacing fluid, flowing in the funnel channel but outside the funnel structure, towards the centre of the funnel channel and into the funnel structure. These features further space out droplets in the funnel structure.

The funnel outlet may comprise side openings configured to introduce additional spacer fluid into the funnel structure. The side openings or gaps allow spacing fluid to enter the funnel outlet from outside the funnel structure. This may allow spacing fluid from the narrowing funnel channel to enter the funnel outlet. These features further space out droplets in the funnel outlet.

The microfluidic structure may further comprise a second funnel structure, wherein a second region of the second funnel structure is configured to receive droplets from the funnel outlet of the first funnel structure. The second funnel structure may be downstream of the first funnel structure. The second funnel structure may have a funnel outlet in which, in use, droplets are spaced out further than in the funnel outlet of the first funnel structure. Both funnel structures increase the spacing between droplets, therefore having multiple funnel structures further increases the spacing between droplets. The funnel opening of the second funnel structure may have a first region configured to receive the spacer fluid and a second region configured to receive droplets from the funnel outlet of the first funnel structure. The first region of the second funnel structure may be located in a narrowing region of the funnel channel, so that spacing fluid forced inwards by the decreasing cross-section of the funnel channel enters the second funnel structure and increases spacing between droplets in the second funnel structure. The microfluidic structure may further include further funnel structures, wherein each funnel structure further increases the spacing between droplets.

The main channel may have curved shape downstream of the first inlet. The spiraling, bending, or curved shape of the main channel aligns droplets on a side of the main channel. The curve causes a difference in velocity between spacing fluid travelling on an inside of the bend and spacing fluid travelling on an outside of the bend. This difference in velocity causes a pressure gradient, which forces the droplets to align on a side of the main channel, therefore spacing the droplets out. This helps droplets align and have an even spacing from each other.

According to a further embodiment of the invention, there is provided use of a microfluidic structure as described above, wherein the spacing fluid and/or a carrier fluid containing the droplets is an oil comprising a fluorosurfactant.

According to a further embodiment of the invention, there is provided a method of spacing out droplets in a microfluidic structure, the method comprising providing a main channel for guiding droplets in a spacing fluid; providing a first inlet for introducing droplets in the main channel; providing a second inlet for introducing a spacing fluid into the main channel, wherein a cross-sectional area of the main channel decreases downstream from the first inlet and the second inlet; the method further comprising:

introducing droplets into the main channel from the first inlet; introducing a spacing fluid into the main channel from the second inlet; and guiding the droplets and the spacing fluid through the main channel having a decreasing cross-sectional area to increase spacing between adjacent droplets.

Firstly, droplets are added to or the number of droplets in a given area are diluted by a quantity of oil phase (spacing fluid) larger than the quantity of droplets in an open area. The open area with the mixture of oil and droplets is reduced into a narrow channel gradually so that droplets are pushed away from each other when moving into the narrow channel. This increase spacing between the droplets.

In a preferred embodiment, the method may comprise providing side channel opening into the main channel at the first inlet. The method may further comprise guiding a spacing fluid through the main channel of the microfluidic structure from the second inlet; and introducing droplets into the main channel from the side channel opening. Droplets travelling through the side channel opening change direction when entering the main channel. This slows down the droplets in comparison to the flow of spacing fluid and increases the distance between droplets when in the main channel.

The method may comprise providing a dilution chamber; providing a droplet inlet for introducing droplets into the dilution chamber; providing a carrier fluid inlet for introducing a flow of carrier fluid into the dilution chamber; and providing a dilution chamber outlet, wherein the first inlet is configured to receive droplets from the dilution chamber outlet, and wherein the dilution chamber is configured such that droplets flow through the dilution chamber outlet arranged one behind each other. Before the step of introducing droplets into the main channel from the first inlet, the method may further comprise introducing droplets into the dilution chamber from the droplet inlet; introducing a carrier fluid into the dilution chamber from the carrier fluid inlet; and guiding the droplets and the carrier fluid through the dilution chamber and the dilution chamber outlet to align the droplets one behind each other. Aligning the droplets to be in single file when entering the first inlet improves the regularity of the spacing of droplets further downstream in the microfluidic structure.

In further preferred embodiment, the method may comprise providing a flow-aligning structure for aligning the flow of the spacing fluid into the second inlet wherein the flow-aligning structure is located upstream of the second inlet; and aligning the flow of the spacing fluid using the flow using the flow aligning structure.

In a further preferred embodiment, the method may comprise providing a spacing chamber wherein the main channel is inside the spacing chamber, and wherein the first inlet is configured to introduce droplets into the main channel from outside a plane of the microfluidic structure; providing a third inlet for introducing a flow of spacing fluid into the spacing chamber. The method may further comprise introducing a flow of spacing fluid into the spacing chamber from the third inlet; and introducing at least a portion of the flow of spacing fluid into the main channel from the second inlet.

The method may comprise providing an outlet channel from the main channel; and providing a first funnel structure with a funnel opening, wherein the funnel opening has a first region configured to receive the spacing fluid and a second region configured to receive droplets from the outlet channel, and wherein the funnel structure has a funnel outlet in which, in use, droplets are spaced out further than in the output channel. The method may further comprise introducing a flow of spacing fluid into the first region of the first funnel structure; introducing droplets into the second region of the funnel structure from the outlet channel; guiding the droplets and the spacing fluid through the funnel outlet.

Once the droplets are flowing through the narrowing main channel they enter the second region of the funnel structure from the outlet channel. Spacing fluid may enter the funnel structure from the spacing chamber through the first region of the funnel structure. This fluid further increases spacing between droplets in the main channel.

We note that methods, structures and devices as described throughout the specification are equally applicable to droplets of varying size e.g. picodroplets, nanodroplets, and microdroplets, and embodiments described herein are not limited to a particular size of a droplet.

### BRIEF DESCRIPTION OF THE DRAWINGS

These and other aspects of the invention will now be further described, by way of example only, and with reference to the accompanying figures, wherein like numerals refer to like parts throughout, and in which:

FIG. 1 shows a schematic of a microfluidic structure according to embodiments of the present invention;

FIG. 2 shows a video snapshot of droplets in a dilution chamber of a microfluidic structure according to embodiments of the present invention;

FIG. 3 shows a schematic of a microfluidic structure according to embodiments of the present invention;

FIG. 4 shows a video snapshot of droplets in a microfluidic structure according to embodiments of the present invention;

FIG. 5 shows a schematic of a microfluidic structure according to embodiments of the present invention;

FIG. 6(a) shows a schematic of a flow-aligning structure of the microfluidic structure of FIG. 5;

FIG. 6(b) shows a channel of the flow-aligning structure of FIG. 6(a);

FIG. 6(c) shows video snapshot of droplets in a microfluidic structure according to embodiments of the present invention;

FIG. 7 shows a schematic of a microfluidic structure according to embodiments of the present invention; and

FIG. 8 shows a video snapshot of droplets in a microfluidic structure according to embodiments of the present invention.

### DETAILED DESCRIPTION OF PREFERRED EMBODIMENTS

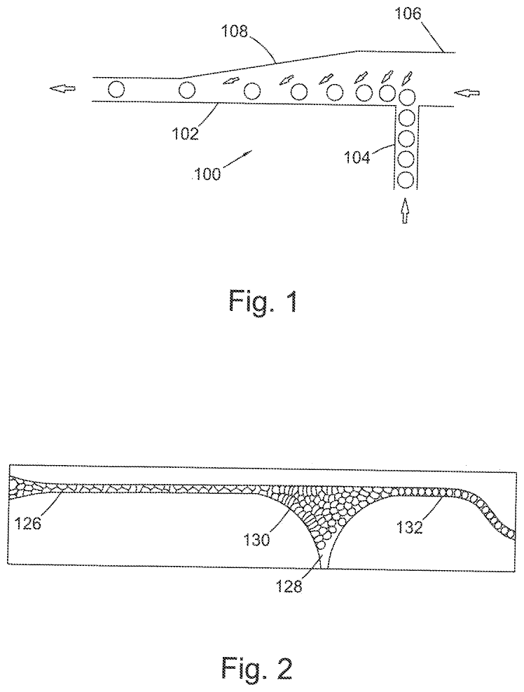

FIG. 1 shows a schematic of a microfluidic device or structure according to an embodiment of the invention. The microfluidic structure 100 includes a main channel 102, a picodroplet inlet 104, and a spacing fluid inlet 106.

The spacing fluid inlet 106 extends from the main channel 102 so that spacing fluid travels in a continuous direction from the spacing fluid inlet 106 to the main channel 102. In this embodiment shown, the spacing fluid inlet 106 is continuous with the main channel 102 so that the fluid flowing through the spacing fluid inlet 106 spaces out droplets when entering the main channel 102.

The picodroplet inlet 104 is arranged at a side channel on a first side of the main channel 102 and is angled with respect to the main channel 102, which allows picodroplets to change direction when travelling from the picodroplet inlet 104 to the main channel 102. In this embodiment, the picodroplet inlet 104 is substantially perpendicular to the main channel 106.

The main channel 102 has a sloping sidewall 108 on a second side of the main channel 102, opposite to the picodroplet inlet 104. This means that the cross-sectional area of the main channel 102 decreases downstream from the junction with the picodroplet inlet 104. The main channel 102 is widest at the junction with the picodroplet inlet 104, and upstream at the spacing fluid inlet 106, and narrows downstream from the picodroplet inlet 104 and the spacing fluid inlet 106.

Spacing fluid is introduced into the main channel 102 from the spacing fluid inlet 106, and picodroplets are introduced into the main channel 102 from the picodroplet inlet 104. The picodroplets change direction as they enter the main channel 102, and spacing fluid enters behind them. As the main channel 102 narrows, the spacing fluid increases the distance between the picodroplets in the main channel 102.

In this embodiment, and in other embodiments shown, the spacing fluid is an oil and the droplet includes particles, cells, or entities in an aqueous suspension or solution, However, the spacing fluid may alternatively include water and the droplets may be oil droplets.

FIG. 2 shows a video snapshot of droplets in a dilution chamber 130 of a microfluidic structure according to embodiments of the present invention. The microfluidic structure includes a droplet inlet 126, a carrier fluid inlet 128, and a dilution chamber 130. Droplets enter the dilution chamber 130 from the droplet inlet 126. The droplets from the droplet inlet 126 arrive with very little carrier fluid and so minimise their surface area to volume ratio which results in the droplets arriving in a zigzag arrangement, with droplets diagonally side by side rather than being one behind each other.

Carrier fluid (in this embodiment, a carrier oil) in introduced into the dilution chamber 130 from a carrier fluid inlet 128. The dilution chamber 130 has a wider cross section on a side with the droplet inlet 126 and an outlet 132, compared to the cross section on a side with the carrier fluid inlet 128. The cross section increases more towards the side with the droplet inlet 126 and an outlet 132, with the dilution chamber 130 having a curved funnel shape. The introduction of the carrier fluid in the dilution chamber 130 aligns the droplets so that droplets flowing through the outlet 132 are in single file.

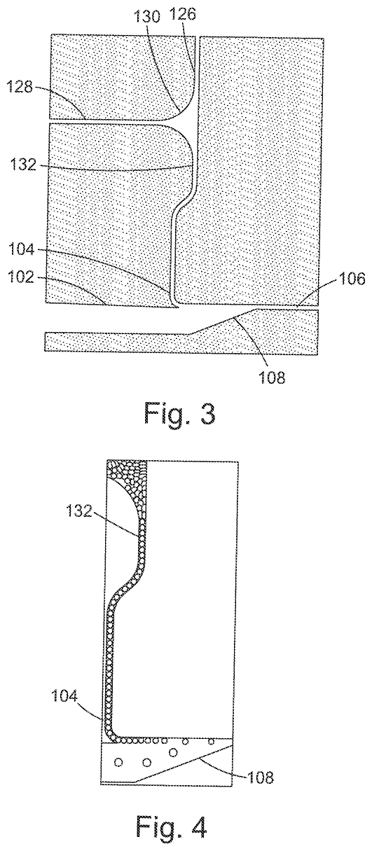

FIG. 3 shows a schematic of a microfluidic structure according to embodiments of the present invention, and FIG. 4 shows a video snapshot of droplets in the microfluidic structure of FIG. 3. The microfluidic structure of FIG. 3 includes the dilution chamber 130, droplet inlet 126, carrier fluid inlet 128 and outlet 132 of FIG. 2, with the structure of FIG. 1. The first inlet 104 is configured to receive droplets in a single file from the outlet 132. Having droplets arrive in single file improves the regular spacing of droplets within the microfluidic structure downstream from the outlet 132. In this embodiment, the first inlet 104 is parallel to the main channel 102 with droplets in carrier fluid arriving flowing in an opposite direction to the flow of spacing fluid through the spacing fluid inlet 106 and the main channel.

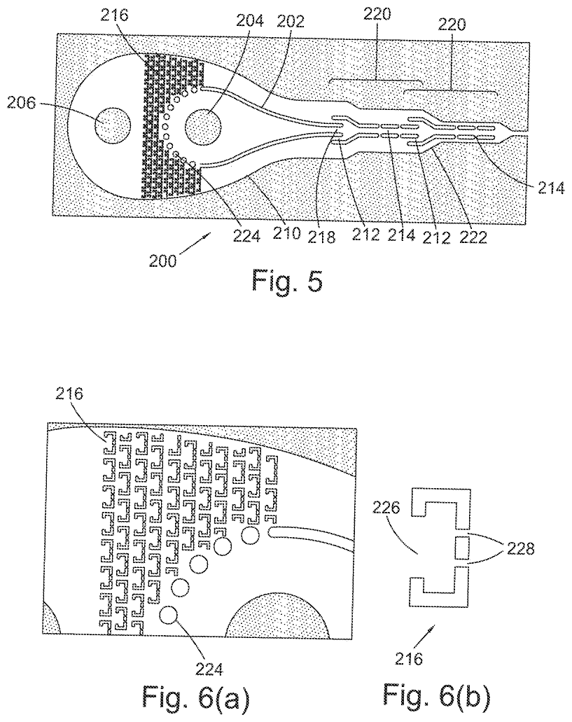

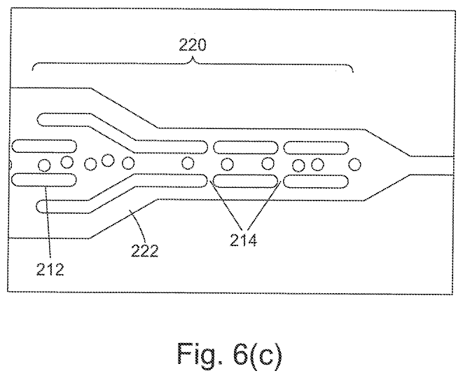

FIG. 5 shows a schematic of a microfluidic device or structure 200 according to a further embodiment of the invention, and FIG. 6(c) shows a video snapshot of picodroplets in the microfluidic structure 200 of FIG. 5. In this embodiment, the microfluidic structure 200 includes a main channel 202 within a spacing chamber 210, a picodroplet inlet 204 and a spacing fluid inlet 206.

The picodroplet inlet 204 is arranged at a first junction connected to the main channel 202 within the spacing chamber 210. The spacing fluid inlet 206 connects to the spacing chamber 210 but is upstream of the picodroplet inlet 204 and the main channel 202. The main channel has a teardrop shape narrowing towards an outlet 218.

Two funnel structures 220 are arranged downstream of the main channel. The funnel structures have inlets 212 and gaps 214 are present on the sides of the funnel structures 220 so that spacing fluid can enter the funnel structures 220 through the inlets 212 or gaps 214. The inlets 212 are arranged such that spacing fluid enters the funnel structures 220 in a direction substantially parallel to the direction of flow in the funnel structures 220. The spacing fluid entering the funnel structures 220 through the inlets 212 and gaps 214 spaces out the droplets flowing through the funnel structures 220.

The funnel structures 220 are located within a larger funnel channel 222. The funnel channel 222 has a decreasing cross-sectional area such that spacing fluid in the funnel channel 222 but outside the inner funnels 220 is forced into the funnels 220 through the inlets 212 or gaps 214 and spaces out droplets in the funnel 220.

A flow-aligning structure 216 as shown in FIG. 6(a) is located between the spacing fluid inlet 206 and the picodroplet inlet 204. The flow-aligning structure 216 includes a series of smaller channel structures as shown in FIG. 6(b), which align the flow of spacing medium or spacing fluid in a direction towards the picodroplet inlet 204 and to the main channel 202. In this embodiment, the flow aligning structure 216 is a series of rows of channels in the direction of flow through the spacing chamber 210, each having an opening aperture 226 to allow fluid to enter and one or more smaller exit apertures 228 to reduce the amount of fluid flowing through each channel. The rows of channels are offset with respect to each other, so that the exit aperture of one channel is aligned with a gap between channels in an adjacent row of channels.

A semi-circular grid structure 224 is adjacent to the flow-aligning structure 216. In this embodiment, the grid structure 224 is an array of inline filters. Some spacing fluid from the spacing fluid inlet 206 passes through the flow-aligning structure 216 and the grid structure 224, and then into the main channel 202 upstream of the picodroplet inlet 204. The rest of the flow of spacing fluid passes through the flow-aligning structure 216 and around the outside of the main channel 202 inside the spacing chamber 210. This may then enter the funnels 220 through the inlets 212 or gaps 214 along the sides of the funnels 220.

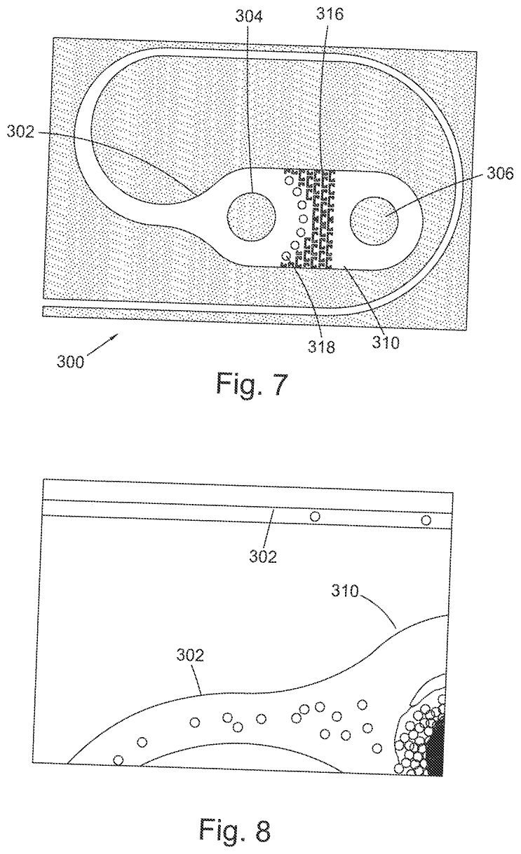

FIG. 7 shows a schematic of a microfluidic structure 300 according to a further embodiment of the present invention, and FIG. 8 shows a video snapshot of picodroplets in the microfluidic structure 300 of FIG. 7. In this embodiment, the microfluidic structure 300 includes a main channel 302 connected to a spacing chamber 310, a picodroplet inlet 304 and a spacing fluid inlet 306.

The picodroplet inlet 304 is arranged at a first junction with the spacing chamber 310, and the spacing fluid inlet 306 is arranged at a second junction with the spacing chamber 310. The main channel 302 joins the spacing chamber 310 downstream from the picodroplet inlet 304 and the spacing fluid inlet 36. The spacing fluid inlet 306 is upstream of the picodroplet inlet 304 and the main channel 302.

Similar to the embodiment shown in FIGS. 5 and 6, a flow-aligning structure 316 is located between the spacing fluid inlet 306 and the picodroplet inlet 304. The flow-aligning structure 316 includes a series of smaller dotted structures, which align the flow of spacing fluid from the spacing fluid inlet 306 in a direction towards the picodroplet inlet 304 and to the main channel 302. A semi-circular grid structure 324 is adjacent to the flow-aligning structure 316. The spacing fluid passes from the spacing fluid inlet 306 and the flow of the spacing fluid is aligned towards the picodroplet inlet 304 and the main channel 302 extending from the spacing chamber 310.

The main channel 302 has a narrowing cross section downstream from the picodroplet inlet 302 and the spacing chamber 310. The decreasing cross section of the main channel 302 slows down the flow of spacing fluid and the picodroplets and spaces out the picodroplets. In this embodiment, the main channel 302 has a curved shape so that it spirals around the spacing chamber 310. The curved or bent shape of the main channel 302 allows picodroplets to align on an outside surface of the bend of the curved main channel 302, that the picodroplets are spaced out from each other as they travel downstream of the spacing chamber 310.

Although aspects and embodiments of the invention described throughout the specification refer to picodroplets (which may be defined as droplets having a volume of less than one nano-litre), the skilled person will appreciate that aspects of the invention and embodiments generally as described herein may equally be used for droplets with other sizes. for example droplets having a volume of 1-1000 nanolitres or microdroplets.

No doubt, many other effective alternatives will occur to the skilled person. It will be understood that the invention is not limited to the described embodiments and encompasses modifications apparent to those skilled in the art lying within the spirit and scope of the claims appended hereto.

1. A microfluidic structure for spacing out droplets, the structure comprising:
a main channel for guiding droplets in a spacing fluid;
a first inlet for introducing droplets into the main channel; and
a second inlet for introducing a spacing fluid into the main channel, wherein a cross-sectional area of the main channel decreases in the direction of flow starting from the first inlet.

2. A microfluidic structure according to claim 1, comprising a side channel opening into the main channel at the first inlet.

3. A microfluidic structure according to claim 2, wherein at the first inlet, the side channel is angled between 30° and 90° with respect to the main channel.

4. A microfluidic structure according to claim 2, wherein the first inlet is arranged on a first side of the main channel, and wherein the main channel comprises a droplet spacing region in which the first side of the main channel is straight and a second side of the main channel opposite the first side converges towards the first side of the main channel.

5. A microfluidic structure according to claim 1, wherein the second inlet is upstream from the first inlet.

6. A microfluidic structure according to claim 1, further comprising an outlet channel from the main channel, wherein a spacing between droplets in the main channel increases as the droplets flow through the main channel into the outlet channel.

7. A microfluidic structure according to claim 1, further comprising:
a dilution chamber;
a droplet inlet for introducing droplets into the dilution chamber;
a carrier fluid inlet for introducing a flow of carrier fluid into the dilution chamber; and
a dilution chamber outlet, wherein the first inlet is configured to receive droplets from the dilution chamber outlet, and wherein the dilution chamber is configured such that droplets flow through the dilution chamber outlet arranged one behind each other.

8. A microfluidic structure according to claim 1, wherein the second inlet comprises a grid across the main channel.

9. A microfluidic structure according to claim 8, further comprising a flow-aligning structure for aligning the flow of the spacing fluid into the second inlet, wherein the flow-aligning structure is located upstream of the second inlet.

10. A microfluidic structure according to claim 8, wherein the main channel has a funnel shape.

11. A microfluidic structure according to claim 8, further comprising:
a spacing chamber wherein the main channel is inside the spacing chamber, and
wherein the first inlet is configured to introduce droplets into the main channel from outside a plane of the microfluidic structure; and
a third inlet configured to introduce a flow of spacing fluid into the spacing chamber.

12. A microfluidic structure according to claim 8, further comprising;
an outlet channel from the main channel; and
a first funnel structure with a funnel opening, wherein the funnel opening has a first region configured to receive the spacer fluid and a second region configured to receive droplets from the outlet channel, and wherein the funnel structure has a funnel outlet in which, in use, droplets are spaced out further than in the output channel.

13. A microfluidic structure according to claim 12, wherein the second region is a central region of the funnel opening and the first region lies to either side of the second region,

14. A microfluidic structure according to claim 12, further comprising a funnel channel, wherein the funnel structure is inside the funnel channel, and wherein a cross-sectional area of the funnel channel decreases downstream from the funnel opening.

15. A microfluidic structure according to claim 12, wherein the funnel outlet comprises side openings configured to introduce additional spacing fluid into the funnel structure.

16. A microfluidic structure according to claim 12, further comprising a second funnel structure wherein a second region of the second funnel structure is configured to receive droplets from the funnel outlet of the first funnel structure.

17. A microfluidic structure according to claim 1, wherein the main channel has a curved shape downstream of the first inlet.

18. Use of a microfluidic structure according to claim 1, wherein the spacing fluid and/or a carrier fluid containing the droplets is an oil comprising a fluorosurfactant.

19. A method of spacing out droplets in a microfluidic structure, the method comprising:
providing a main channel for guiding droplets in a spacing fluid;
providing a first inlet for introducing droplets in the main channel;
providing a second inlet for introducing a spacing fluid into the main channel, wherein a cross-sectional area of the main channel decreases downstream from the first inlet and the second inlet;
the method further comprising:
introducing droplets into the main channel from the first inlet;
introducing a spacing fluid into the main channel from the second inlet; and
guiding the droplets and the spacing fluid through the main channel having a decreasing cross-sectional area to increase spacing between adjacent droplets.

20. A method according to claim 19, the method comprising:
providing a side channel opening into the main channel at the first inlet; and
the method further comprising:
guiding a spacing fluid through the main channel of the microfluidic structure from the second inlet: and
introducing droplets into the main channel from the side channel opening.

21. (canceled)

22. (canceled)

23. (canceled)

24. (canceled)
